(19) United States
(12) Patent Application Publication
(10) Pub. No.: US 2021/0379883 A1
(43) Pub. Date: Dec. 9, 2021

(54) METHOD FOR PRODUCING NEGATIVE OR NEAR-ZERO THERMAL EXPANSION MEMBER

(71) Applicant: MITSUBISHI HEAVY INDUSTRIES, LTD., Tokyo (JP)

(72) Inventors: Hiroyuki SAKAMOTO, Tokyo (JP); Hikaru KUROSAKI, Tokyo (JP); Tomohiro ISHIDA, Tokyo (JP)

(21) Appl. No.: 17/411,407

(22) Filed: Aug. 25, 2021

Related U.S. Application Data
(63) Continuation of application No. PCT/JP2019/043037, filed on Nov. 1, 2019.

(30) Foreign Application Priority Data
Mar. 29, 2019 (JP) 2019-069023

(51) Int. Cl. B32B 38/10; E04B 1/19

(52) U.S. Cl. CPC B32B 38/10; B32B 2419/00; E04B 1/19

(57) ABSTRACT

A method for producing a negative or near-zero thermal expansion member using a first material and a second material having a smaller linear expansion coefficient than the first material, the method including: a preparation step (S1) for preparing a laminate in which a plurality of first plate materials comprising the first material and a plurality of second plate materials comprising the second material are alternately laminated; and an in-plane processing step (S2) for performing perforation processing on the second plate materials from a plurality of directions in an in-plane direction including a plane orthogonal to a lamination direction of the first plate materials and the second plate materials.

Priority is claimed on Japanese Patent Application No. 2019-069023, filed Mar. 29, 2019, and this application is a continuation application based on a PCT Patent Application No. PCT/JP2019/43037. The content of the PCT Application is incorporated herein by reference.

### TECHNICAL FIELD

The present invention relates to a method for producing a negative or near-zero thermal expansion member.

### BACKGROUND ART

Research on a material called a metamaterial is attracting attention. The metamaterial is a material having properties that cannot be realized in materials in the related art.

As the metamaterial, for example, an optical metamaterial having a negative refractive index has been realized so far. Meanwhile, with the commercialization of 3D printers, a material called a mechanical metamaterial is also being commercialized.

As the mechanical metamaterial, a material having a negative Poisson's ratio or a negative or near-zero thermal expansion member having a negative or zero coefficient of thermal expansion has particularly attracted attention.

As a specific example, a negative or near-zero thermal expansion member stated in PTL 1 below is known. In the negative or near-zero thermal expansion material stated in PTL 1, a third element is disposed in a gap between octahedral ligands or tetrahedral ligands made of a metal oxide exhibiting negative thermal expansion.

Accordingly, the displacement between the molecules of the metal oxide caused by the rotation of the ligands is suppressed, and the negative thermal expansion is suppressed. As a result, the thermal expansion can be reduced to zero as a whole.

In the above-described technique stated in PTL 1, the negative or near-zero thermal expansion member is obtained by chemically manipulating a molecular structure.

Meanwhile, an approach has also been proposed in which a plurality of materials are combined, and unit cells, each of which has a lattice structure, are combined with each other to obtain a negative or near-zero thermal expansion member.

In the approach, for example, a method for assembling materials, each of which is molded in a rod shape, to create a lattice structure, or a method for three-dimensionally shaping the structure using a 3D printer can be considered.

### CITATION LIST

### Patent Literature

[PTL 1] Japanese Unexamined Patent Application Publication No. 2002-173359

### SUMMARY OF INVENTION

### Technical Problem

However, the method for assembling the materials one by one as described above is not realistic from the viewpoint of accuracy and productivity. In addition, the method using a 3D printer has difficulties in handling a plurality of types of materials. Particularly, when a 3D printer is used, there are great difficulties in forming a negative or near-zero thermal expansion member from a plurality of metallic materials. The reason is that, for example, a powder bed type 3D printer has difficulties in mixing the plurality of types of materials in the same layer.

The present invention has been made to solve the above problems, and an object of the present invention is to provide a method for producing a negative or near-zero thermal expansion member, which is capable of easily and accurately producing a negative or near-zero thermal expansion member.

### Solution to Problem

According to one aspect of the present invention, there is provided a method for producing a negative or near-zero thermal expansion member using a first material and a second material having a coefficient of linear expansion smaller than a coefficient of linear expansion of the first material, the method including: a preparation step of preparing a laminate in which a plurality of first plate members made of the first material and a plurality of second plate members made of the second material are alternately laminated; and an in-plane processing step of performing penetration processing on the second plate member in a plurality of directions included in an in-plane direction including a plane orthogonal to a lamination direction of the first plate members and the second plate members.

According to the method, when heat is applied to the negative or near-zero thermal expansion member, the first plate member having a relatively large coefficient of linear expansion expands in the in-plane direction. Meanwhile, since the coefficient of linear expansion of the second plate member is relatively small, the amount of thermal expansion is small.

As a result, thermal expansion occurs in the in-plane direction, but thermal expansion in the lamination direction orthogonal to the in-plane direction is negative or zero, or a smaller positive thermal expansion is exhibited than when each of the first material and the second material is used alone.

As described above, according to the production method, the negative or near-zero thermal expansion member can be obtained only by performing the penetration processing on the laminate. Accordingly, the negative or near-zero thermal expansion member can be obtained more easily and in a shorter time than, for example, in a method using a 3D printer.

In the method for producing a negative or near-zero thermal expansion member, in the in-plane processing step, a plurality of beams which connect the first plate members to each other may be formed from the second plate member by performing the penetration processing.

According to the method, the second plate member is formed in the plurality of beams only by preparing the laminate in which the first plate members and the second plate members are alternately laminated, and linearly performing the penetration processing on the second plate member in the plurality of directions included in the in-plane direction of the second plate member. The plurality of beams connect the first plate members to each other. When heat is applied to the negative or near-zero thermal expansion member, the first plate member having a relatively large coefficient of linear expansion expands in the in-plane direction.

Meanwhile, since the coefficient of linear expansion of the beam formed from the second plate member is relatively small, the amount of thermal expansion is small. As a result, thermal expansion occurs in the in-plane direction, but thermal expansion in the lamination direction orthogonal to the in-plane direction is negative or zero, or a smaller positive thermal expansion is exhibited than when each of the first material and the second material is used alone.

As described above, according to the production method, the negative or near-zero thermal expansion member can be obtained only by performing the penetration processing on the laminate. Further, the negative or near-zero thermal expansion member can be obtained more easily and accurately than, for example, in a method in which the first plate members are sequentially connected to each other by the beams formed in advance.

In the method for producing a negative or near-zero thermal expansion member, in the in-plane processing step, the second plate member may be processed to form a three-dimensional truss structure including the plurality of beams.

According to the method, the three-dimensional truss structure is formed by the plurality of beams. Here, the three-dimensional truss structure indicates a structure in which quadrangular pyramids formed by the plurality of beams are continuously combined.

It is known that in the three-dimensional truss structure, when external force is applied, only compression or pulling in a direction in which the beam extends acts on each of the beams.

Therefore, in the negative or near-zero thermal expansion member configured as described above, the direction of force generated in the beam when thermal expansion occurs in the first plate member is limited to an axial direction of the beam, so that the coefficient of linear expansion of the beam can be easily adjusted.

Specifically, the coefficient of linear expansion to be revealed can be easily changed by changing the thickness (cross-sectional area in an extending direction) of the first plate member or the beam. Accordingly, the characteristics of the negative or near-zero thermal expansion member can be determined with a high degree of freedom.

Further, the quadrangular pyramids forming the three-dimensional truss structure can be easily formed only by performing the penetration processing in two directions orthogonal to each other in the plane of the second plate member.

In the method for producing a negative or near-zero thermal expansion member, in the in-plane processing step, the penetration processing may be performed on the second plate member in two directions intersecting each other and included in the in-plane direction.

According to the method, the negative or near-zero thermal expansion member can be easily and accurately obtained only by performing the penetration processing in the two directions intersecting each other and included in the in-plane direction of the second plate member. Therefore, the negative or near-zero thermal expansion member can be produced at a lower cost.

Further, various three-dimensional structures including the quadrangular pyramids forming the three-dimensional beam structure can be easily formed by performing such penetration processing.

The method for producing a negative or near-zero thermal expansion member may further include a diagonal processing step of performing the penetration processing on the laminate in a plurality of directions inclined with respect to the lamination direction and the in-plane direction, to form the second plate member into a perforated structure while forming the first plate member into a base plate having a lattice plate shape.

According to the method, the penetration processing can be performed not only on the second plate member but also on the first plate member adjacent thereto in the lamination direction by executing the diagonal processing step. Since the first plate member is formed in the base plate having a lattice pattern, the characteristics of the negative or near-zero thermal expansion member can be changed with a higher degree of freedom than, for example, when processing is performed only on the second plate member. Namely, according to the production method, various negative or near-zero thermal expansion members having different characteristics can be obtained.

In the method for producing a negative or near-zero thermal expansion member, in the diagonal processing step, the penetration processing may be performed in four directions intersecting each other when viewed in the lamination direction.

According to the method, in the diagonal processing step, the characteristics of the negative or near-zero thermal expansion member can be made uniform in the in-plane direction orthogonal to the lamination direction by performing the penetration processing in the four directions intersecting each other when viewed in the lamination direction. Namely, the negative or near-zero thermal expansion member in which there is no deviation in the directionality of thermal expansion in the in-plane direction can be obtained only by performing the penetration processing.

Further, the beam can be formed to be even thinner by a combination with penetration processing in the in-plane direction. Accordingly, the characteristics of the negative or near-zero thermal expansion member can be more precisely adjusted.

In the method for producing a negative or near-zero thermal expansion member, in the diagonal processing step, the penetration processing may be performed while leaving a projecting portion projecting in the in-plane direction from a corner of an intersection portion of the first plate member having a lattice pattern, and while leaving a part of the perforated structure overlapping the projecting portion when viewed in a processing direction.

According to the method, while leaving a part of the perforated structure overlapping the projecting portion in the processing direction, the penetration processing is performed, so that the beam can be formed of the left part of the perforated structure.

In other words, since the projecting portion is formed, the penetrating shape required in the penetration processing can be further simplified. Accordingly, the negative or near-zero thermal expansion member can be produced easily and at low cost.

### Advantageous Effects of Invention

According to the present invention, it is possible to provide the method for producing a negative or near-zero thermal expansion member, which is capable of easily and accurately producing the negative or near-zero thermal expansion member.

### BRIEF DESCRIPTION OF DRAWINGS

FIG. 1 is an overall view illustrating a configuration of a negative or near-zero thermal expansion member according to a first embodiment of the present invention.

FIG. 2 is a view of the negative or near-zero thermal expansion member when viewed in an A direction in FIG. 1.

FIG. 3 is a descriptive view illustrating a behavior of the negative or near-zero thermal expansion member according to the first embodiment of the present invention.

FIG. 4 is a flowchart illustrating a method for producing a negative or near-zero thermal expansion member according to the first embodiment of the present invention.

FIG. 5 is a view illustrating a configuration of a laminate according to the first embodiment of the present invention.

FIG. 6 is a view illustrating a part of an in-plane processing step according to the first embodiment of the present invention.

FIG. 7 is a view illustrating another part of the in-plane processing step according to the first embodiment of the present invention.

FIG. 8 is an overall view illustrating a configuration of a negative or near-zero thermal expansion member according to a second embodiment of the present invention.

FIG. 9 is a view of the negative or near-zero thermal expansion member when viewed in the A direction in FIG. 8.

FIG. 10 is a view of the negative or near-zero thermal expansion member when viewed in a B direction in FIG. 8.

FIG. 11 is a flowchart illustrating a method for producing a negative or near-zero thermal expansion member according to the second embodiment of the present invention.

FIG. 12 is a view illustrating a configuration of a laminate according to the second embodiment of the present invention.

FIG. 13 is a view illustrating a first processing step included in a diagonal processing step according to the second embodiment of the present invention.

FIG. 14 is a view of the laminate after the first processing step when viewed in a B1 direction of FIG. 13.

FIG. 15 is a view illustrating a second processing step included in the diagonal processing step according to the second embodiment of the present invention.

FIG. 16 is a view of the laminate after the second processing step when viewed in a B2 direction of FIG. 15.

FIG. 17 is a view illustrating a third processing step included in the diagonal processing step according to the second embodiment of the present invention.

FIG. 18 is a view of the laminate after the third processing step when viewed in a B3 direction of FIG. 17.

FIG. 19 is a view illustrating a fourth processing step included in the diagonal processing step according to the second embodiment of the present invention.

FIG. 20 is a view of the laminate after the fourth processing step when viewed in a B4 direction of FIG. 19.

FIG. 21 is a view illustrating a part of an in-plane processing step according to the second embodiment of the present invention.

FIG. 22 is a view of the laminate when viewed in the A direction of FIG. 21.

FIG. 23 is a view illustrating another part of the in-plane processing step according to the second embodiment of the present invention.

FIG. 24 is a view of the negative or near-zero thermal expansion member when viewed in an A′ direction of FIG. 23.

### DESCRIPTION OF EMBODIMENTS

### First Embodiment

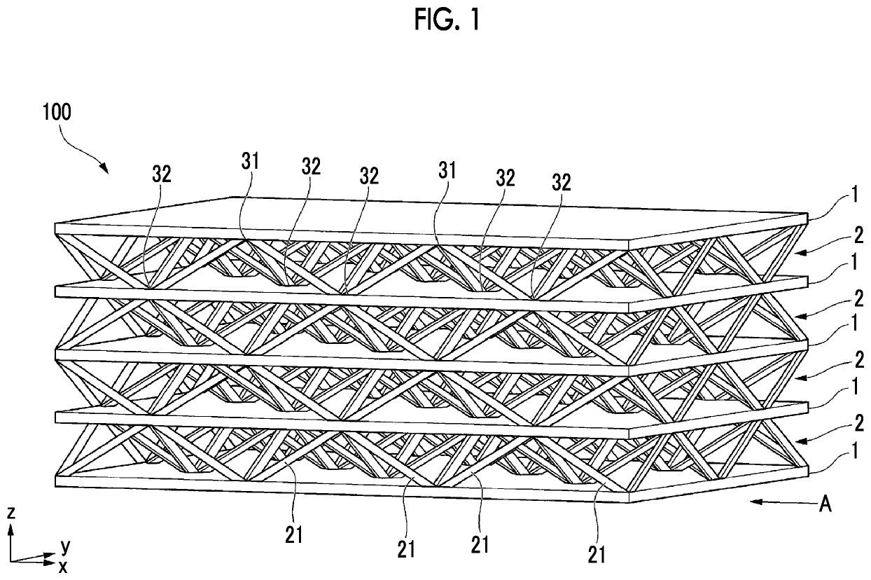

A first embodiment of the present invention will be described with reference to FIGS. 1 to 7. As illustrated in FIG. 1, a negative or near-zero thermal expansion member 100 according to the present embodiment is formed in a plate shape, and includes a plurality of base plates 1 arranged at intervals in a thickness direction, and a three-dimensional beam structure 2 that connects the base plates 1 to each other.

The coefficient of linear expansion of a material forming the base plate 1 is relatively larger than the coefficient of linear expansion of a material forming the three-dimensional beam structure 2. The plurality of base plates 1 are disposed at equal intervals to face each other over the entire extending region.

The three-dimensional beam structure 2 includes a plurality of beams 21 extending in directions intersecting each other. Each of the beams 21 has a rod shape.

In the three-dimensional beam structure 2, four beams 21 connect one (first support point 31) of a plurality of support points, which are arranged in a lattice pattern on a surface of one base plate 1 of a pair of the base plates 1 facing each other, and four support points (second support points 32), which are arranged in a lattice pattern on a surface of the other base plate 1.

When viewed in a direction orthogonal to the base plate 1, the first support point 31 and the second support point 32 are arranged at positions where the positions thereof do not overlap each other, and are arranged in a lattice pattern at equal intervals from each other. Namely, the four beams 21 form a quadrangular pyramid having one first support point 31 as an apex and a bottom surface of a quadrangular shape formed on the base plate 1 by four second support points 32. The plurality of beams 21 have the same length as each other.

The three-dimensional beam structures 2 described above are arranged to be mirror-symmetric in a direction orthogonal to a plane in which the base plate 1 is widened, with the base plate 1 interposed therebetween. In other words, the other first support point 31 is located on a side (on the other surface of the base plate 1) opposite one first support point 31 on one surface of the base plate 1.

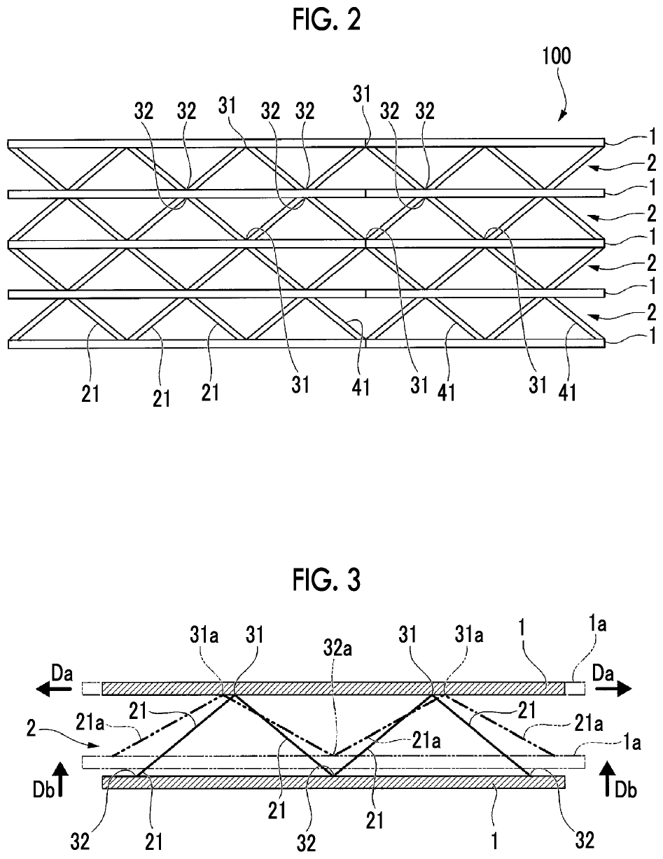

In the example of FIGS. 1 and 2, a configuration where the base plate 1 and the three-dimensional beam structure 2 are laminated over four layers is illustrated. In addition, as illustrated in FIG. 2, when viewed in an A direction in FIG. 1, namely, when viewed in a direction in which the beams 21 overlap each other, a through-hole 41 having an isosceles triangular cross-sectional shape and penetrating therethrough in the A direction is formed between a pair of the beams 21 and the base plate 1. In other words, when viewed in the A direction, the through-hole 41 has the same cross-sectional area and cross-sectional shape over the entire region in the A direction.

Furthermore, the A direction is expressed in more detail as follows.

First, as illustrated in FIG. 1, an extending direction of one side of the base plate 1 in the negative or near-zero thermal expansion member 100 is an x-axis, an extending direction of the other side orthogonal to the one side is set along a y-axis, and a direction orthogonal to an x-axis and the y-axis is set along a z-axis.

At this time, for the x-axis and the y-axis, the unit length is the half the distance between the first support points 31 and the second support point 32, which are arranged in the directions of the x-axis and the y-axis and are adjacent to each other, and for the z-axis, the unit length is the interval between the base plates adjacent to each other.

Namely, the base plate 1 is widened in an x-y plane, and the base plate 1 and the three-dimensional beam structure 2 are laminated in a z-axis direction (incidentally, in the following description, a plane direction including the x-y plane may be called an “in-plane direction”, and the z-axis direction may be called a “lamination direction”).

In this case, the A direction is expressed as (−1, 1, 0) as a three-dimensional vector. Namely, when the unit lengths of the x-axis and the y-axis are equal in the plane in which the base plate 1 is widened, the A direction corresponds to a direction facing 45° diagonally to the negative or near-zero thermal expansion member 100.

Next, a behavior of the negative or near-zero thermal expansion member 100 will be described with reference to FIG. 3.

In FIG. 3, only the pair of base plates 1 and the three-dimensional beam structure 2 of one layer provided between the base plates 1 are typically illustrated.

When heat is applied to the negative or near-zero thermal expansion member 100, the base plates 1 and the three-dimensional beam structure 2 exhibit the following behavior.

First, the base plate 1 expands in a plane direction (arrow Da direction in FIG. 3) in which the base plate 1 extends (base plate 1a). Therefore, the interval between the first support points 31 described above is widened.

Here, since the coefficient of linear expansion of the beam 21 is smaller than the coefficient of linear expansion of the base plate 1, the amount of thermal expansion of the beam 21 is smaller than the amount of thermal expansion of the base plate 1. Accordingly, the interval between the first support points 31 described above is widened (first support points 31a), and the pair of beams 21 are pulled in a direction in which the base plate 1 expands (beams 21a). As a result, the other base plate 1 is displaced in a direction to approach the one base plate 1 (arrow Db direction in FIG. 3).

In such a manner, expansion occurs in the plane direction (Da direction) in which the base plate 1 is widened, whereas thermal expansion in the thickness direction (lamination direction: Db direction) orthogonal to the plane direction is suppressed (coefficient of linear expansion in the lamination direction is a value smaller than that of the beam 21, namely, is zero or negative). In addition, a shrinkage in the lamination direction can be made zero by changing the thickness of the beam 21.

On the other hand, when heat is applied to a solid plate member made of a uniform material unlike the negative or near-zero thermal expansion member 100 described above, thermal expansion inherent to the material occurs in the plane direction and the thickness direction. Namely, in the negative or near-zero thermal expansion member 100, characteristics which are difficult to reveal in the related art can be realized.

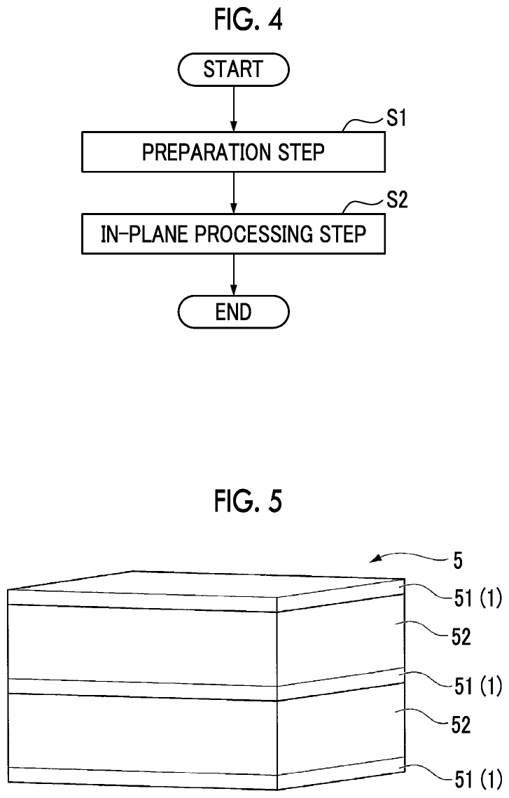

Subsequently, a method for producing the negative or near-zero thermal expansion member 100 will be described with reference to FIGS. 4 to 7. As illustrated in FIG. 4, the production method includes a preparation step S1 and an in-plane processing step S2.

In the preparation step S1, a laminate 5 in which a plurality of first plate members 51 and a plurality of second plate members 52, each of which has a plate shape, are alternately laminated is prepared (refer to FIG. 5).

The coefficient of linear expansion of a material (first material) forming the first plate member 51 is set to be larger than the coefficient of linear expansion of a material (second material) forming the second plate member 52.

As the first material and the second material, for example, stainless steel (SUS304, SUS310, SUS316, or SUS410) or a material selected from Ti6Al4V, a Ni-based alloy (Inconel 600 or 718), a high chrome steel (9Cr or 12Cr), a 2.25Cr-1Mo material, and the like is appropriately used.

More specifically, for example, it can be considered that SUS304 is used as the first material and SUS410 having a coefficient of linear expansion smaller than that of SUS304 is used as the second material. In addition, for example, it is also possible to use SUS304 as the first material, and to use Ti6Al4V as the second material. In addition, an aluminum alloy, copper, carbon steel, or a non-metallic material can also be used as the first material or the second material.

In addition, the thickness dimension (dimension in the lamination direction) of the first plate member 51 is usually set to be smaller than the thickness dimension of the second plate member 52. Specific examples of the laminate 5 described above include clad steel (crimped steel) and a member laminated by overlay welding. Incidentally, in the present embodiment, the first plate member 51 forms the base plate 1 described above.

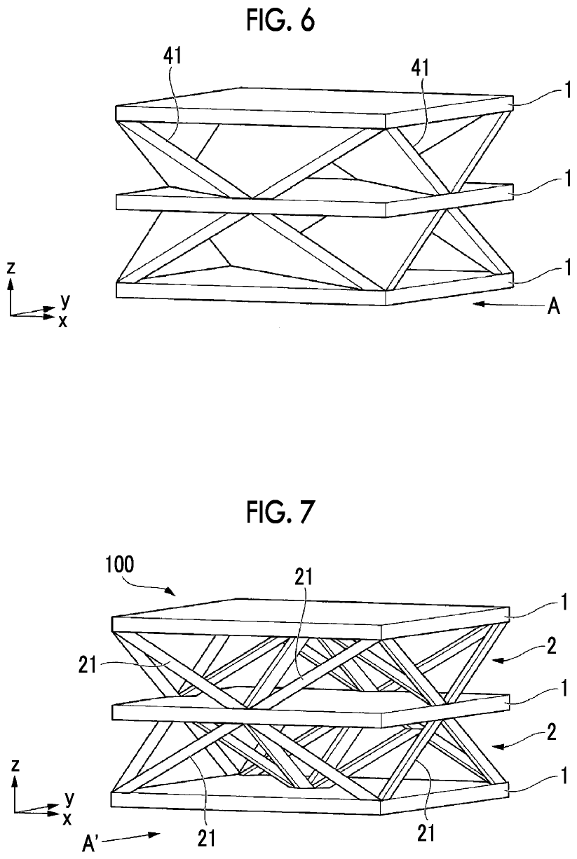

After the preparation step S1, the in-plane processing step S2 is executed. In the in-plane processing step S2, first, penetration processing is performed only on the second plate member 52 in the A direction described above (refer to FIG. 6).

The penetration processing referred to here indicates drilling (machining) by cutting, laser machining, or water jet. More specifically, in the penetration processing, the through-hole 41 having the same cross-sectional shape and cross-sectional area in a linear direction is formed in the object to be processed.

In the present embodiment, in order to form the three-dimensional beam structure 2 described above, the through-hole 41 having an isosceles triangular cross-sectional shape illustrated in FIG. 2 is formed in the second plate member 52.

After the penetration processing in the A direction is completed, the same penetration processing is performed in an A′ direction intersecting (orthogonal to) the A direction in the plane of the second plate member 52 (refer to FIG. 7).

The A′ direction is (1, 1, 0) when expressed in a vector as described above. Namely, in the in-plane processing step S2, penetration processing is performed in two directions included in the plane (in-plane direction) in which the second plate member 52 is widened. Accordingly, the three-dimensional beam structure 2 including the plurality of beams 21 is formed between the pair of base plates 1.

As described above, all the steps of the method for producing the negative or near-zero thermal expansion member 100 according to the present embodiment are completed.

As described above, according to the method for producing the negative or near-zero thermal expansion member 100 according to the present embodiment, the second plate member 52 is formed in the plurality of beams 21 only by preparing the laminate 5 in which the first plate members 51 and the second plate members 52 are alternately laminated, and linearly performing penetration processing on the second plate member 52 in a plurality of directions included in the in-plane direction of the second plate member 52. The plurality of beams 21 connect the first plate members 51 to each other.

When heat is applied to the negative or near-zero thermal expansion member 100, the first plate member 51 having a relatively large coefficient of linear expansion expands in the in-plane direction. Meanwhile, since the coefficient of linear expansion of the beam 21 formed from the second plate member 52 is relatively small, the amount of thermal expansion is small.

As a result, thermal expansion occurs in the in-plane direction, but thermal expansion in the lamination direction orthogonal to the in-plane direction is suppressed (coefficient of linear expansion in the lamination direction is a value smaller than that of the beam 21, namely, is zero or negative).

As described above, according to the production method, the negative or near-zero thermal expansion member 100 can be obtained only by performing simple machining (penetration processing) on the laminate 5. Accordingly, the negative or near-zero thermal expansion member 100 can be obtained more easily and in a shorter time than, for example, in a method using a 3D printer.

In addition, fabrication using a plurality of types of materials, which is difficult with a 3D printer, can be easily performed.

Further, the negative or near-zero thermal expansion member 100 can be obtained more easily and accurately than, for example, in a method in which the first plate members 51 are sequentially connected to each other by the beams 21 formed in advance.

Further, according to the production method, the three-dimensional truss structure 2 is formed by the plurality of beams 21. Here, the three-dimensional truss structure 2 indicates a structure in which quadrangular pyramids formed by the plurality of beams 21 are continuously combined.

It is known that in the three-dimensional truss structure 2, when external force is applied, only compression or pulling in a direction in which the beam 21 extends acts on each of the beams 21. Therefore, in the negative or near-zero thermal expansion member 100 configured as described above, the direction of force generated in the beam 21 when thermal expansion occurs in the first plate member 51 is limited to an axial direction of the beam 21, so that the coefficient of linear expansion to be revealed can be easily adjusted.

Specifically, the coefficient of linear expansion of the negative or near-zero thermal expansion member 100 can be easily changed by changing the thickness (cross-sectional area in the extending direction) of the first plate member 51 or the beam 21. Accordingly, the characteristics of the negative or near-zero thermal expansion member 100 can be determined with a high degree of freedom.

Further, the quadrangular pyramids forming the three-dimensional truss structure 2 can be easily formed only by performing penetration processing in two directions orthogonal to each other in the plane of the second plate member 52.

In addition, according to the production method, the negative or near-zero thermal expansion member 100 can be easily and accurately obtained only by performing penetration processing in two directions intersecting each other and included in the in-plane direction of the second plate member 52. Therefore, the negative or near-zero thermal expansion member 100 can be produced at a lower cost.

Further, various three-dimensional structures including the quadrangular pyramids forming the three-dimensional beam structure 2 can be easily formed by performing such penetration processing.

The first embodiment of the present invention has been described above. Incidentally, various changes or modifications can be made to the above configuration or method as long as the changes or modifications do not depart from the concept of the present invention. For example, in the first embodiment, an example in which in the in-plane processing step S2, penetration processing is performed in the A direction and the A′ direction orthogonal to each other has been described.

However, depending on the characteristics of the negative or near-zero thermal expansion member 100 which is a target, penetration processing does not necessarily need to be performed in two directions orthogonal to each other, and penetration processing can also be performed in two directions intersecting each other at an angle of less than 90°, or penetration processing can also be performed in a number of directions other than 2.

### Second Embodiment

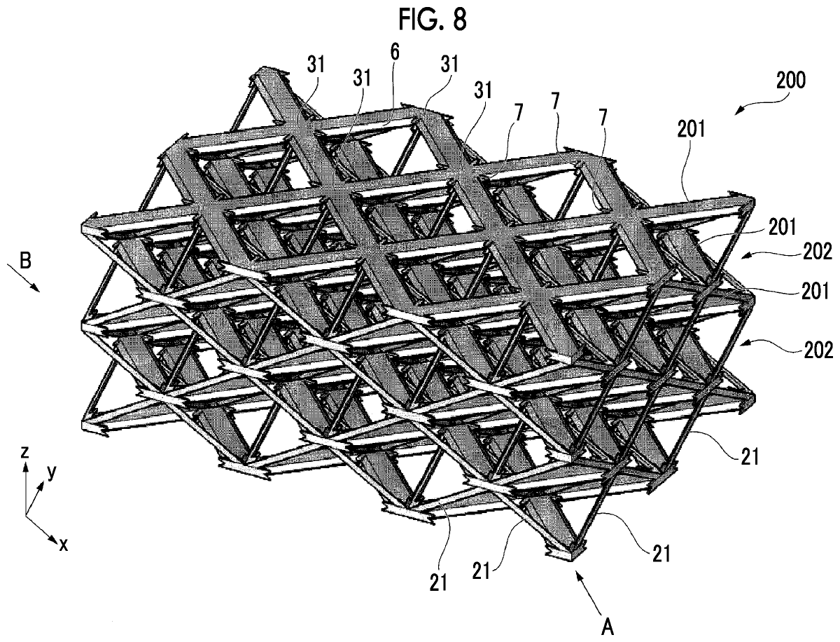

Next, a second embodiment of the present invention will be described with reference to FIGS. 8 to 10. Incidentally, the same configurations or steps as those in the first embodiment are denoted by the same reference signs, and detailed description thereof will be omitted.

As illustrated in FIG. 8, a negative or near-zero thermal expansion member 200 according to the present embodiment includes a base plate 201 and a three-dimensional beam structure 202, and the shape of the base plate 201 is different from that of the base plate 1 of the first embodiment.

Specifically, a hole (base plate hole portion 6) of a quadrangular shape having a plurality (four) of the first support points 31 described above as apexes is formed in the base plate 201. Accordingly, the base plate 201 has a lattice pattern that connects the first support points 31 to each other.

Further, a protrusion (projecting portion 7) projecting in an in-plane direction of the base plate 201 is provided at a corner of an intersection portion of the base plate 201 having a lattice pattern. As will be described in detail later, the projecting portion 7 is provided to protect a part of the second plate member 52 in a processing direction to form the beams 21 when penetration processing is performed. Namely, the projecting portion 7 has the same width (dimension in a direction orthogonal to a projecting direction in the in-plane direction) as that of the beam 21 that is finally obtained.

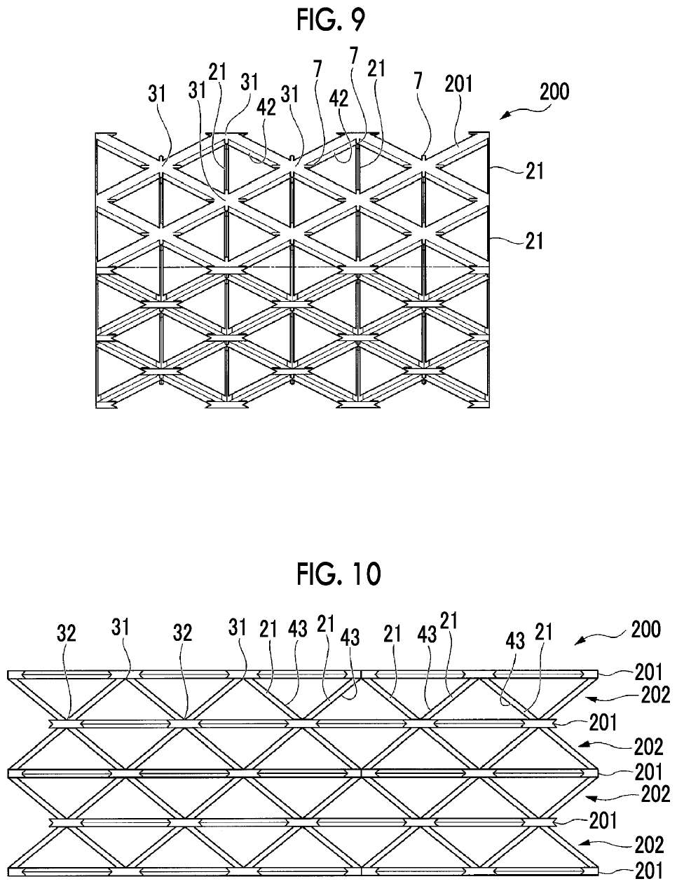

FIG. 9 is a view of the negative or near-zero thermal expansion member 200 when viewed in a diagonally upward direction (hereinafter, referred to as a B direction) with respect to a side of the base plate 201 and with respect to a normal direction of the base plate 201 illustrated in FIG. 8.

The B direction is expressed in detail as (0, 1, −1) as a vector, and corresponds to a 45° diagonal direction when the unit lengths of the y-axis and the z-axis are equal.

As illustrated in the same figure, when viewed in the B direction, through-holes 42, each of which has an isosceles triangular shape having three first support points 31 as apexes, are formed. Further, one beam 21 which connects a pair of the first support points 31, which are located in a plane including the lamination direction, to each other is located between the through-holes 42 adjacent to each other.

In addition, as illustrated in FIG. 10, when the negative or near-zero thermal expansion member 200 is viewed in the A direction ((−1, 1, 0) as a vector) described above in FIG. 8, namely, when viewed in a direction in which the beams 21 overlap each other, a through-hole 43 having an isosceles triangular cross-sectional shape and penetrating therethrough in the A direction is formed between a pair of the beams 21 and the base plate 201.

In other words, when viewed in the A direction, the through-hole 43 has the same cross-sectional area and cross-sectional shape (isosceles triangular shape) over the entire region in the A direction.

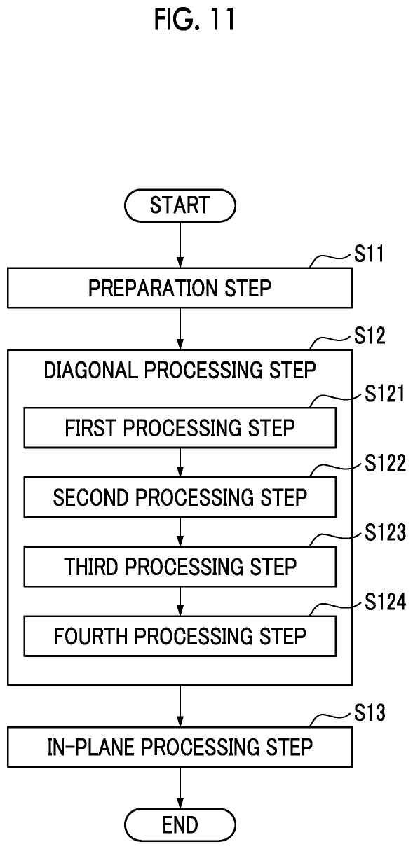

Next, a method for producing the negative or near-zero thermal expansion member 200 according to the present embodiment will be described with reference to FIGS. 11 to 24. As illustrated in FIG. 11, the production method includes a preparation step S11, a diagonal processing step S12, and an in-plane processing step S13.

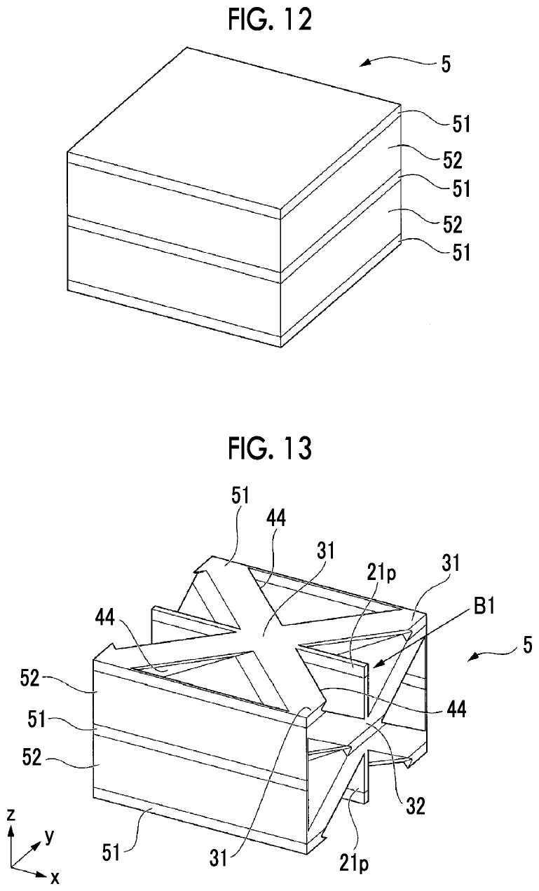

In the preparation step S11, the laminate 5 is prepared in the same manner as in the first embodiment described above. The laminate 5 is formed by alternately laminating the plurality of first plate members 51 and the plurality of second plate members 52, each of which has a plate shape (refer to FIG. 12).

The coefficient of linear expansion of the first plate member 51 is set to be larger than the coefficient of linear expansion of the second plate member 52. In addition, the thickness dimension (dimension in the lamination direction) of the first plate member 51 is usually set to be smaller than the thickness dimension of the second plate member 52.

Specific examples of the laminate 5 described above include, for example, clad steel (crimped steel) and a member laminated by overlay welding.

After the preparation step S11, the diagonal processing step S12 is executed. In the diagonal processing step S12, penetration processing is performed on the laminate 5 in a plurality of directions (four directions) inclined with respect to the lamination direction and the in-plane direction.

The diagonal processing step S12 will be described in further detail. The diagonal processing step S12 includes a first processing step S121, a second processing step S122, a third processing step S123, and a fourth processing step S124.

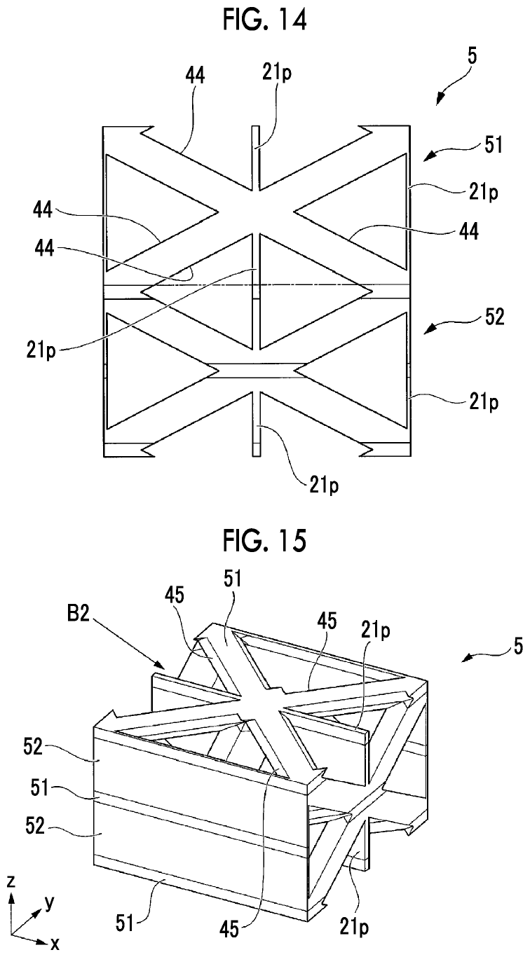

In the first processing step S121, as illustrated in FIG. 13, first, penetration processing is performed on the laminate 5 in a B1 direction. The B1 direction is a direction expressed as (−1, 0, −1) in vector notation. In the penetration processing, a through-hole 44 having an isosceles triangular cross-sectional shape and extending in the B1 direction is formed, and a portion which becomes the beam 21 in a subsequent step (intermediate beam 21p) is left (refer to FIG. 14). The intermediate beam 21p has a plate shape that is widened in an x-z plane. The intermediate beam 21p includes a portion formed of the first plate member 51 and a portion formed of the second plate member 52.

Next, the second processing step S122 is executed. In the second processing step S122, penetration processing is performed in a B2 direction that is axisymmetric with the B1 direction with respect to the lamination direction of the laminate 5 (refer to FIG. 15).

The B2 direction is a direction expressed as (1, 0, −1) in vector notation. Through the second processing step S122, when viewed in the B2 direction, the laminate 5 has a shape as illustrated in FIG. 16. Namely, a through-hole 45 having an isosceles triangular cross-sectional shape and extending in the B2 direction is formed.

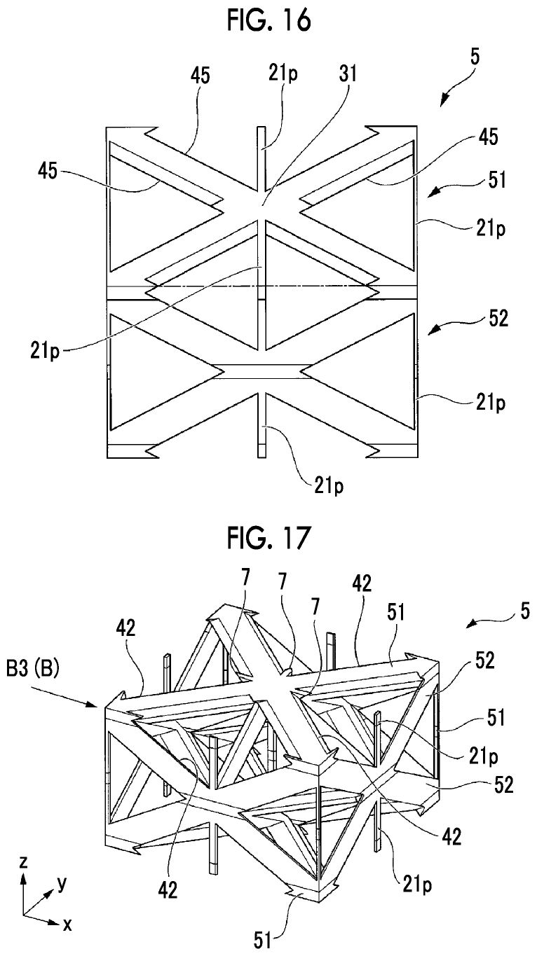

Next, the third processing step S123 is executed. In the third processing step S123, penetration processing is performed in a B3 direction that is a direction rotated by 90° from the B1 direction with respect to the lamination direction of the laminate 5 (refer to FIG. 17).

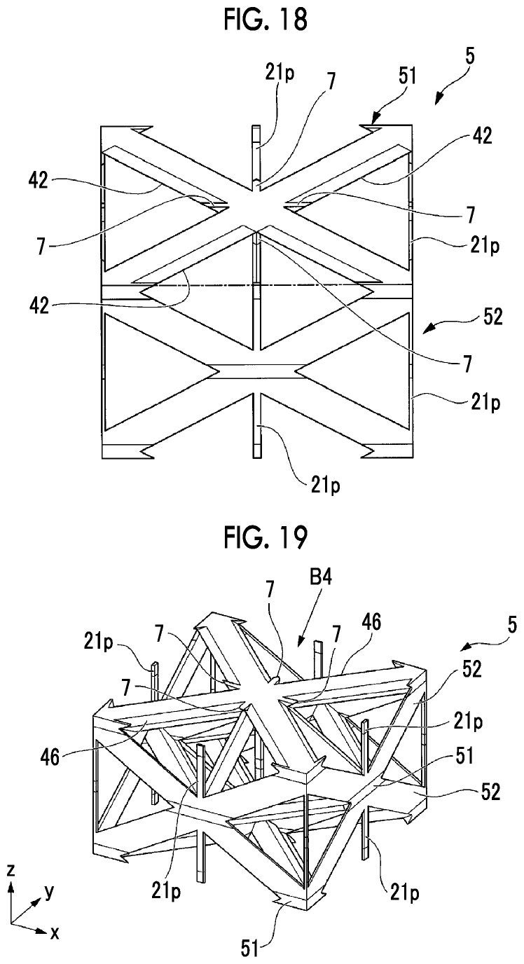

Incidentally, the B3 direction is the same direction as the B direction described above, and is expressed as (0, 1, −1) in vector notation. Through the third processing step S123, the laminate 5 has a shape as illustrated in FIG. 18 when viewed in the B3 direction. Namely, the through-hole 42 having an isosceles triangular cross-sectional shape and extending in the B3 direction is formed, and a part of the intermediate beam 21p is removed to form the projecting portion 7 described above.

Further, after the third processing step S123, the fourth processing step S124 is executed. In the fourth processing step S124, penetration processing is performed in a B4 direction that is axisymmetric with the B3 direction with respect to the lamination direction of the laminate 5 (refer to FIG. 19).

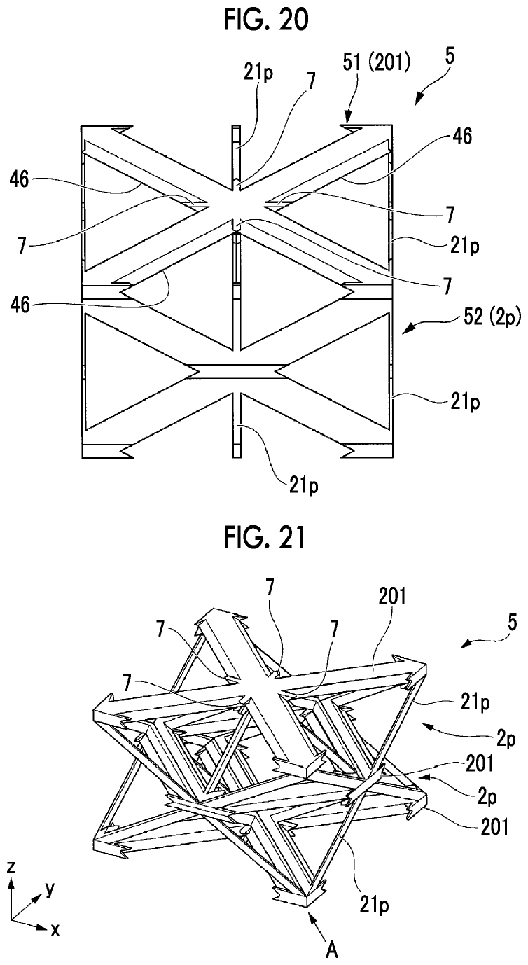

The B4 direction is expressed as (0, −1, −1) in vector notation. Through the fourth processing step S124, the laminate 5 has a shape as illustrated in FIG. 20 when viewed in the B4 direction. Namely, a through-hole 46 having an isosceles triangular cross-sectional shape and extending in the B4 direction is formed (refer to FIG. 20).

As described above, the diagonal processing step S12 is completed. As described above, in the diagonal processing step S12, penetration processing is performed on the laminate 5 in the four directions intersecting (orthogonal to) each other when viewed in the lamination direction. Through the diagonal processing step S12, the first plate member 51 of the laminate 5 forms the base plate 201, and the second plate member 52 forms a perforated structure 2p as an intermediate structure.

After the diagonal processing step S12, the same in-plane processing as in the first embodiment is performed on the perforated structure 2p (in-plane processing step S13). In the in-plane processing step S13, first, penetration processing is performed only on the perforated structure 2p in the A direction described above (refer to FIG. 21).

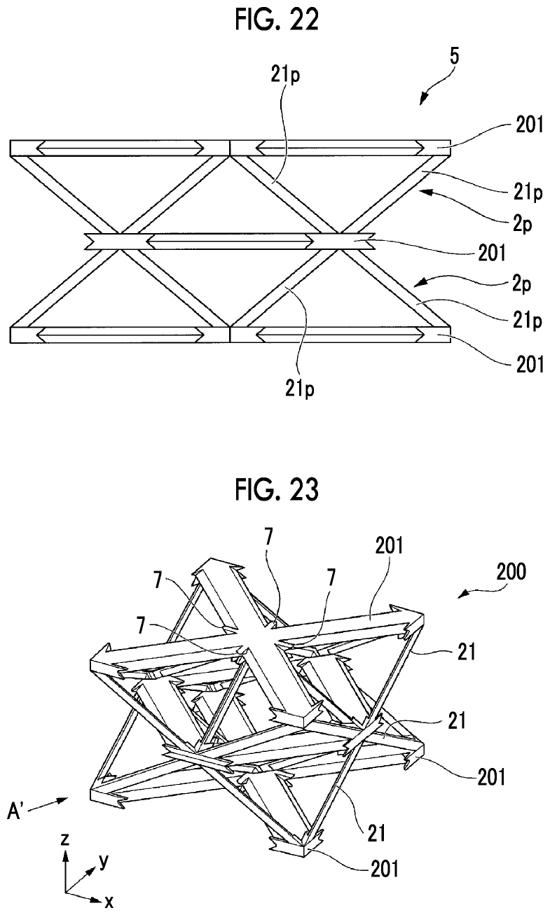

Accordingly, when viewed in the A direction, the perforated structure 2p has a shape as illustrated in FIG. 22. Further, after the penetration processing in the A direction is completed, the same penetration processing is performed in the A′ direction intersecting (orthogonal to) the A direction in the plane of the second plate member 52 (refer to FIG. 23).

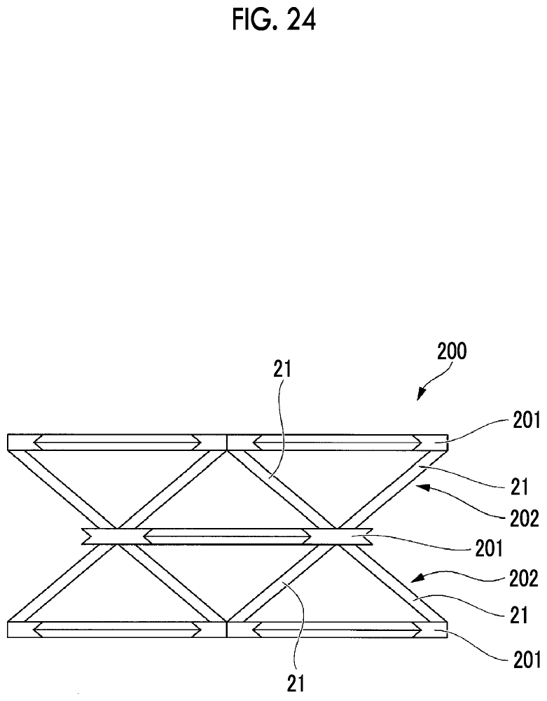

Accordingly, the negative or near-zero thermal expansion member 200 in which the three-dimensional beam structure 2 including the plurality of beams 21 is formed between the pair of base plates 201 is completed. At this time, when viewed in the A′ direction, the negative or near-zero thermal expansion member 200 has a shape as illustrated in FIG. 24.

As described above, all the steps of the method for producing the negative or near-zero thermal expansion member 200 according to the present embodiment are completed.

As described above, according to the production method, penetration processing can be performed not only on the second plate member 52 but also on the first plate member 51 adjacent thereto in the lamination direction by executing the diagonal processing step S12.

Since the first plate member 51 is formed in the base plate 1 having a lattice pattern, the characteristics of the negative or near-zero thermal expansion member 100 can be changed with a higher degree of freedom than, for example, when processing is performed only on the second plate member 52. Namely, according to the production method, various negative or near-zero thermal expansion members 100 having different characteristics can be obtained.

According to the production method, in the diagonal processing step S12, the characteristics of the negative or near-zero thermal expansion member 100 can be made uniform in the in-plane direction orthogonal to the lamination direction by performing penetration processing in the four directions intersecting each other when viewed in the lamination direction. Namely, the negative or near-zero thermal expansion member 100 in which there is no deviation in the directionality of thermal expansion in the in-plane direction can be obtained only by performing penetration processing.

Further, the beam 21 can be formed to be even thinner by a combination with penetration processing in the in-plane direction. Accordingly, the characteristics of the negative or near-zero thermal expansion member 100 can be more precisely adjusted.

Further, according to the production method, while leaving a part of the perforated structure 2p overlapping the projecting portion 7 in the processing direction, penetration processing is performed, so that the left part of the perforated structure 2p can be protected from the cutting range of a tool, laser, water jet, or the like, and the beam 21 can be formed of the part of the perforated structure 2p. In other words, since the projecting portion 7 is formed, the penetrating shape required in the penetration processing can be further simplified. Accordingly, the negative or near-zero thermal expansion member 100 can be produced easily and at low cost.

The second embodiment of the present invention has been described above. Incidentally, various changes or modifications can be made to the above configuration or method as long as the changes or modifications do not depart from the concept of the present invention.

For example, in the second embodiment, an example in which in the diagonal processing step S12, penetration processing is performed in the B1 direction, the B2 direction, the B3 direction, and the B4 direction orthogonal to each other has been described. However, depending on the characteristics of the negative or near-zero thermal expansion member 100 which is a target, the four directions do not necessarily need to be orthogonal to each other, and penetration processing can also be performed in four directions intersecting each other at an angle of less than 90° or larger than 90°, or penetration processing can also be performed in a number of directions other than 4.

### INDUSTRIAL APPLICABILITY

The present invention is applicable to the method for producing the negative or near-zero thermal expansion member.

### REFERENCE SIGNS LIST

1, 1a, 201: Base plate
2, 202: Three-dimensional beam structure (three-dimensional truss structure)
5: Laminate
6: Base plate hole portion
7: Projecting portion
21, 21a: Beam
31, 31a: First support point
32, 32a: Second support point
41, 42, 43, 44, 45, 46: Through-hole
51: First plate member
52: Second plate member
100, 200: Negative or near-zero thermal expansion member
21p: Intermediate beam
2p: Perforated structure
S1, S11: Preparation step
S12: Diagonal processing step
S121: First processing step
S122: Second processing step
S123: Third processing step
S124: Fourth processing step
S2, S13: In-plane processing step
A, A′, B, B1, B2, B3, B4, Da, Db: Direction

1. A method for producing a negative or near-zero thermal expansion member using a first material and a second material having a coefficient of linear expansion smaller than a coefficient of linear expansion of the first material, the method comprising:
a preparation step of preparing a laminate in which a plurality of first plate members made of the first material and a plurality of second plate members made of the second material are alternately laminated; and
an in-plane processing step of performing penetration processing on the second plate member in a plurality of directions included in an in-plane direction including a plane orthogonal to a lamination direction of the first plate members and the second plate members.

2. The method for producing a negative or near-zero thermal expansion member according to claim 1,
wherein in the in-plane processing step, a plurality of beams which connect the first plate members to each other are formed from the second plate member by performing the penetration processing.

3. The method for producing a negative or near-zero thermal expansion member according to claim 2,
wherein in the in-plane processing step, the second plate member is processed to form a three-dimensional truss structure including the plurality of beams.

4. The method for producing a negative or near-zero thermal expansion member according to claim 1,
wherein in the in-plane processing step, the penetration processing is performed on the second plate member in two directions intersecting each other and included in the in-plane direction.

5. The method for producing a negative or near-zero thermal expansion member according to claim 1, further comprising:
a diagonal processing step of performing the penetration processing on the laminate in a plurality of directions inclined with respect to the lamination direction and the in-plane direction, to form the second plate member into a perforated structure while forming the first plate member into a base plate having a lattice plate shape.

6. The method for producing a negative or near-zero thermal expansion member according to claim 5,
wherein in the diagonal processing step, the penetration processing is performed in four directions intersecting each other when viewed in the lamination direction.

7. The method for producing a negative or near-zero thermal expansion member according to claim 6,
wherein in the diagonal processing step, the penetration processing is performed while leaving a projecting portion projecting in the in-plane direction from a corner of an intersection portion of the first plate member having a lattice pattern, and while leaving a part of the perforated structure overlapping the projecting portion when viewed in a processing direction.
